(19) United States
(12) Patent Application Publication
(10) Pub. No.: US 2007/0039876 A1
(43) Pub. Date: Feb. 22, 2007

(54) Tank with centrifugal system for creating and controlling a water current

(76) Inventor: Giuseppe Augusto Gori, Acton (CA)

Correspondence Address: Mr. Giuseppe Gori, 12030 RR 4, Acton, ON, L7J 2M1, CA

(21) Appl. No.: 11/203,642

(22) Filed: Aug. 15, 2005

(51) Int. Cl. B01D 21/26

(52) U.S. Cl. 210/512.1

(57) ABSTRACT

This is an apparatus for generating a controlled current of fluid in a tank or swimming pool. It can be used for exercise, recreation, rehabilitation, stationary swimming and serious training. It comprises of a tank with a large rectangular inlet at one end through which the fluid is forced by a centrifugal system positioned in front of the tank. The water flow is stabilized before entering the tank, so that a river-like, non-turbulent current is created in the tank, to allow for stationary swimming, exercising, rehabilitation and recreational activities. At the other end of the tank, water is collected and circulated back to the centrifugal system through a large channel or pipe. While others used propellers or paddles to create a water current in a pool, this original apparatus uses a centrifugal system to achieve better results and move efficiently a large quantity of water. The speed of the current is regulated by the user through either an electronic device acting directly on the main induction motor, or through a valve limiting the flow in input to the centrifugal system.

### INTRODUCTION

Purpose: The purpose of this invention is to create a regulated flow of fluid in a tank, or current of water in a swimming pool. For this purpose an apparatus has been created, consisting of a centrifugal system for moving the fluid, a regulating apparatus for regulating the speed and/or quantity of the fluid, and a containment system.

Use: An embodiment of the invention is a swimming pool that can be used for exercise, recreation, rehabilitation, stationary swimming and serious training. The swimmer remains stationary with respect to the pool, but is able to swim at the desired speed by setting the speed of the water current. Conversely, with the provision of an optional electronic sensor mechanism, the speed of the water can automatically be adapted to the speed of the swimmer. Another embodiment, with a tank of appropriate dimensions and sturdiness, can be used for the exercise of animals indoor, such as for the training of racehorses, when the weather conditions outside are not appropriate for regular training.

Advantages: The advantages of using a swimming pool with a generated variable current are many, but mainly relate to the ability to contain the size of the pool, thus allowing the installation of the pool in contained, enclosed and heated rooms enabling year-round use and reducing the operational costs for heating, filtering and water treatment.

Existing designs and products: Designs and products exist, such as swim spas, which create a limited flow through jets directed towards the area of the pool where a person is exercising, or swimming against the water jets. A difficulty with these solutions is that the jets only reach a relative short distance into the water, and within that span they create a turbulent current, which makes swimming difficult and unrealistic.

Designs and products exist, such as wave pools, which generate waves, but not a current flow (see References 7, 9, 10).

Finally, designs and products exist that generate a real current flow through other means, such as propellers (see References 1, 3, 4, 5, 10, 12, 13, 14, 15, 16), wheel paddles (see References 2, 17) and multi-level tanks (see Ref 18).

Those apparatuses that create a current flow through propellers may create difficulties for the swimmer, as the current of water may not be sufficiently stabilized, and directed.

Those apparatuses that create a current flow through paddles create a less turbulent water flow, but tend to require a large mechanism and containment system and, as a result, tend to be more expensive.

The system using different tank levels (in Ref 18) would require a very large tank (e.g. 10,000 gallons) to be able to produce the desired current (10,000 gallons/minute) in the secondary tank for only one minute of operation.

Therefore, three innovations are introduced with this invention: the method for generating the flow, the method for controlling the flow through a regulation system and the method for collecting and re-circulating the fluid in the tank. These three innovations are referred, correspondingly, in the claim section as claims 1, 2, and 3.

1. The Centrifugal System

The use of the centrifugal system described herein, for the purpose of generating the flow, is claimed here as an original innovation.

Other existing patents and apparatuses in the market for similar purpose use different systems, such as propeller systems (directly pushing water in the required direction by the use of a propeller) or paddle systems (directly pushing water in the required direction through a paddle wheel rotating at low speed). In a centrifugal system instead, the fluid is rotated by an impeller at sufficient speed to causes the fluid to move away from the centre of rotation because of centrifugal force.

The centrifugal systems commonly available in the market for moving fluids are generally able to create a high-pressure, but can only move low quantities of water. The centrifugal system described here can instead move a high quantity of fluid at low pressure.

The centrifugal water pumps commonly available in the market are generally used for high-pressure domestic or commercial use, pumping liquids or gases.

Domestic uses include circulation pumps for hot or cold liquids, jet pumps, submerged well pumps and pumps for filter circulation in pools or for water jets in Spas and blowers or fans for air ventilation and forced-air furnaces.

Commercial applications include high-pressure pumps to move fluids, hydraulic pumps for mechanic actuators, and pumps for moving gases (in this case being called vacuum pumps, blowers or fans) for air furnaces, commercial ventilation and process-air applications.

However, such centrifugal systems have never been used before for the purpose claimed herein, that is to move a large quantity of fluid or water (thousands of gallons per minute) required to simulate a river-type current and to allow stationary swimming.

As mentioned above, small centrifugal water pumps have been used for jets in swim Spas and have been proposed for generating a current in a tank (see References 6, 8, 11), but cannot achieve the amount of water flow required for swimming applications. Furthermore these pumps would generate high turbulence and do not include any means for stabilizing, regulating or directing the water flow. Furthermore these proposals do not include the large return channel or channels required for bringing back the water from the back of the pool to the front, required for simulating a river-type flow from one end of the pool to the other.

The centrifugal system described here can instead move a high quantity of fluid at the low pressure required to create such current in the tank.

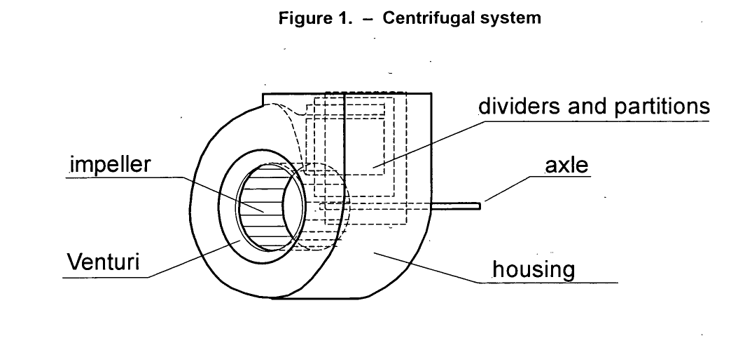

Description: The centrifugal system comprises two main elements:
an electric induction motor of appropriate horsepower, installed on an electrically insulated base, to avoid the risk of shock in case of electrical malfunction or motor melt-down. This motor provides for the rotational force necessary to keep the impeller in motion, and
an impeller, that is a multi-bladed wheel of a large diameter similar to the one used in a commercial air blower, rotating inside a water-tight housing (See FIG. 1).

The impeller is made to rotate at a sufficient speed to causes the fluid to move away from the centre of rotation because of centrifugal force. The centrifugal speed and quantity of the fluid moved can be regulated through a cylindrical valve partially obstructing the water intake surface of the impeller (mechanical solution), or by regulating the speed of the motor (computer-controlled solution).

In addition to the housing shell and the appropriate means to prevent leakage, the centrifugal system includes:
The dividers and partitions separating fluid flows of different speeds and avoiding possible vortex areas within the housing, for reducing turbulence and preventing cavitation, and
the transmission equipment, such as axels, pulleys, belts and/or gears, located in an appropriate housing, for transmitting the rotation of the motor to the impeller.

The fluid coming from the tank and contained within a return channel, is carried to the centrifugal system inlet (See FIG. 1). The centrifugal system pulls the water from this channel and forces it in a rotating motion so that it acquires energy and moves towards the walls of the housing by centrifugal effect and finally escapes the centrifugal system housing through its superior rectangular outlet.

This superior outlet, pointing upwards, is attached to the distributor by means of a rubber collar, to prevent transmission of vibration from the centrifugal system to the distributor.

Water leaving the centrifugal system goes through this rubber collar and enters the distributor.

2. The Regulation System

Mechanically Controlled Flow:

The cylindrical valve described herein, for the purpose of mechanically regulating the flow entering the propelling system housing, is claimed here as an original innovation.

A stainless steel cylinder, guided and sustained within the section of the return channel closest to the centrifugal system, slides inside the propeller through the inlet in the housing and exactly in the opening of the Venturi.

This cylindrical valve can be regulated, manually or through an electric motor, to slide in and out of the propeller to allow less or more flow to enter the centrifugal housing through the Venturi inlet.

When an electric motor is used to control the position of the valve, the electric motor is reversible (for opening and closing), and its rotation is reduced, through a set of gears or pulleys and belts, so as to move the valve slowly into the required position. The degree of opening of the valve, which determines the amount and speed of flow, is shown to the user through a transparent indicator placed, for example, near or inside the border the pool.

A property of the centrifugal system is such that when the inlet flow is discontinued (cylindrical valve closed), the effort and consumption of the motor is reduced to the minimum. When instead the valve is completely open, the effort of the motor is at its maximum and correspondingly the speed and quantity of water are at their maximum. Thus the electric motor is used efficiently with any position of the valve.

Electronically Controlled Flow:

The use of a variable speed drive with specific feedback input options, and the use of a computer with specific software, as described herein, for the purpose of electronically regulating the flow entering the tank, are claimed here as an original innovations.

The use of an automaticfeedback mechanism, described herein, for the purpose of automatically adjust the speed of the flow, is claimed here as an original innovation.

Variable Speed Drive

The user can control the frequency of the variable speed drive, and thus the speed of the flow, through a key pad, through a feedback mechanism and through a program running on a standard PC.

The variable speed drive includes a keypad and the functionality allowing the user to set any desired speed or choose a pre-set speed. The variable speed drive is factory initialized with the maximum speed and all the other parameters as required for this specific application. No additional hardware or software is required.

Automatic Feedback Mechanism

In addition, the pool contains an automatic feedback mechanism consisting of two or more sensors, for the purpose of controlling the speed of the flow by automatic feedback: The feedback mechanism includes a front sensor (or sensors) and a back sensor (or sensors). These are water-tight electronic devices able to send an electric signal (close a circuit) when any object interferes with a laser beam or reaches within the field of detection of the sensors at the front and at the back of the pool.

The front sensor (or sensors), placed near the front of the pool, is able to detect a swimmer who is swimming too close to front wall, where the rectangular water inlet is. Normally this happens when the speed of the water is not fast enough for the swimmer.

The back sensor (or sensors), placed near the back of the pool, is able to detect a swimmer who is swimming too close to the back wall. Normally this happens when the speed of the water is too fast for the swimmer, or the swimmer is tired and has slowly lost ground.

By using these signals from the sensors, the variable speed drive can increase or decrease the water flow speed according to the instant needs of the swimmer, without the need of any manual intervention or regulation. This feature allows for a long, uninterrupted period of training or exercise without the need for the swimmer to use a remote command, without the need for the swimmer to stop and without the need of another person's help.

Persons using the pool for rehabilitation or exercise can also stretch a hand within the field of the sensors, to increase or decrease the speed, effectively using this automatic feedback mechanism as a remote control device.

Feedback Indicators

Optionally several types of feedback indicators can be installed, such as electronic displays, speed indicators, distance indicators, etc., displaying the swimmer's current speed, average speed and other statistical data.

Computer Software

The variable speed drive can be attached via a communication link to a standard computer (PC).

Thus programs running on a standard PC can be used to pre-set a particular exercise program, giving the user the utmost flexibility with regard to exercise times, periods of rest and speeds, in a way that is similar, but more flexible, than what is provided, for example, with top of the line exercise treadmills.

3. Water Collection and Re-Circulation

The water-tight housing for the propelling apparatus, and the distributor mechanism, and the compartment at the back of the tank for collecting the water, and the channel for returning the water to the centrifugal system, as described herein, for the purpose of moving water in a continuous loop inside and outside the tank, are claimed here as original innovations.

The water-tight housing for the propelling apparatus consists of a spiral shell with a circular inlet containing a Venturi type of funnel, and a rectangular outlet which connects, by means of a rubber collar, to the distributor (See FIG. 1).

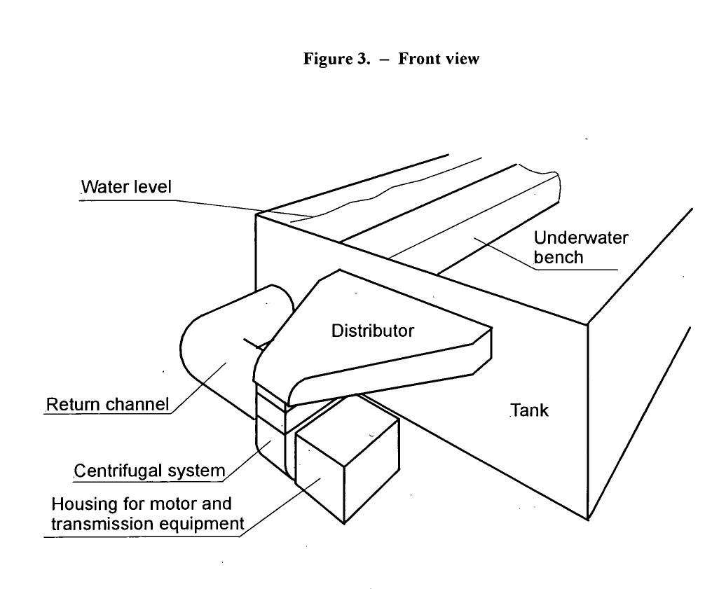

The distributor mechanism for stabilizing, regulating and directing the water flow entering the tank consists of a funnel-like structure, as shown in FIG. 3. This compartment contains several dividers for the purpose of eliminating vortexes and distributing the flow in the desired direction, width and depth.

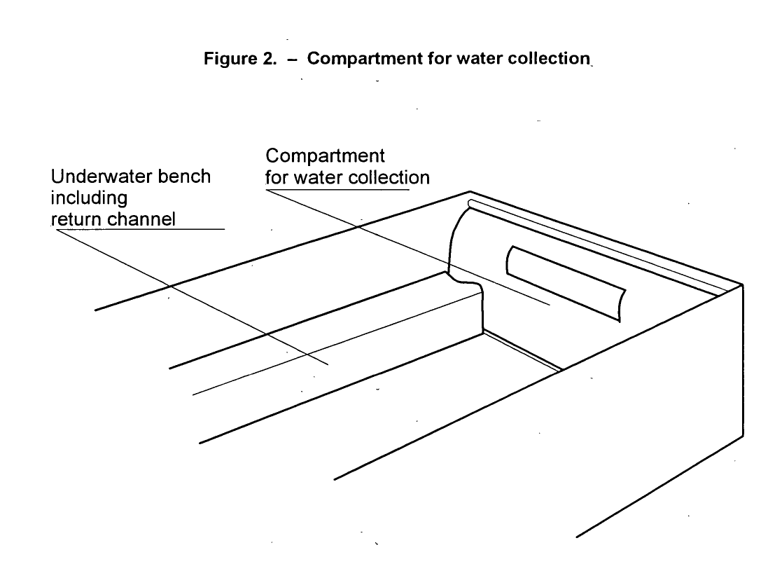

The compartment with a rectangular opening at the back of the tank is used for collecting the water from the pool to be re-circulated. A secondary slanted or curved wall, together with the wall of the tank, creates a compartment through which the water is collected and directed to the return channel(s). The rectangular large opening on the secondary wall is protected with a mesh, to prevent objects from passing through into this compartment together with the fluid (See FIG. 2).

The channel or channels or large pipes for returning the water from the back compartment of the tank to the centrifugal system housing outside the tank at its front end. This channel or channels also serve as support for ergonomic underwater benches. Each channel consists of a large diameter pipe, which contains the water flow, to which the bench is attached. The pipe is attached to the front wall with a flange so that the water can continue outside of the tank into the return channel collector and towards the centrifugal system (See FIG. 3).

The containment system further comprises the following mechanical structures:
a. A tank of variable width, length and height, for containing water or fluid. This tank being suitable for above-ground or in-ground installation.
b. Connecting flanges, collars and other mechanical parts between the various elements of the containment apparatus (tank, centrifugal system housing and distributor).
c. Rubber collars and connections between the various elements of the containment apparatus for reducing and eliminating vibration.

The containment system further comprises the following standard pool devices:
a. A filtering system comprising a pump, a filter housing, a filter, valves, connection hoses, intake hose, skimmer, and other filtering equipment suitable for above-ground or in-ground pools.
b. An apparatus for heating the water or fluid in the tank either through an electric heater, a gas heater, a heat exchange system, or other, including the necessary pumps, tubing, hoses and other equipment suitable for heating above-ground or in-ground pools.

The containment system further comprises customer-selectable options, such as:
c. A jet system for water massage comprising a pump, a number of jet heads, air intake elements, valves, connection tubing and other jet equipment suitable for above-ground or in-ground pools.
d. an additional water circulation apparatus for ionizing and/or purifying the water in the tank as required,
e. additional seat or bench inside the tank,
f. insulation panels or materials for containing noise and preventing heat loss,
g. pool accessories, such as steps, ladders, underwater mirrors, underwater windows, lights, skimmers, pool blankets, security covers and enclosures, liners, coping, and bar-grab systems.

1. A claim of this invention is the use of a centrifugal system as a powerful and efficient method of moving fluids, such as a large quantity of water, for the purpose of creating a regulated flow of fluid or current in a tank. Such centrifugal system comprising:
a. an electric induction motor, with its housing and electrical isolation,
b. a large diameter multi-bladed rotating element (impeller)
c. a water-tight housing, to contain the above impeller,
d. the dividers and partitions for preventing turbulence and vortexes within said housing, a cause for cavitation, and
e. the transmission equipment (axels, pulleys, belts and/or gears) for transmitting the rotation of the motor to said impeller.

2. A further claim of this invention is the design and application of an advanced, multi-functional regulation system for the propelling apparatus, such as the centrifugal system described in claim 1, using any or all of the following methods, for any or all of the following purposes:
a. to control the amount and the speed of fluid, typically water, moved by the centrifugal system through a mechanical apparatus including an in-line cylindrical valve moving along the axis of the cylinder into the inlet of the centrifugal system housing and into its impeller and, as a consequence, controlling the speed of the water current, including all the means for such valve to operate (electrical transformer, relays, diodes, motor, pulleys, gears, axels, mechanical supports, springs and switches), or
b. to control the amount and the speed of fluid, typically water, moved by the centrifugal system through a variable frequency drive (also called “AC drive” or “inverter” or identified by and acronym such as VFD or VSD or other), and
c. to constantly adjust the speed of the current to the speed of the swimmer through an automatic feedback mechanism, through electronic sensors relaying feedback signals to the variable frequency drive, and
d. to perform programmed, timed, automatic or periodic regulation functions, run exercise and rehabilitation programs, monitor the various subsystems, maintain statistics and perform automatic functions, through communication equipment, using any communication technique including copper, fibre or wireless connections and through a personal computer with appropriate software.

3. A further claim of this invention is a containment system for fluids, to be used in conjunction with a propelling apparatus, such as the centrifugal system described in claim 1 comprising:
a. a water-tight housing for the propelling apparatus,
b. a distributor mechanism for stabilizing, regulating and directing the water flow entering the tank,
c. a compartment with a (protected) rectangular opening at the back of the tank for collecting the water to be redirected towards the centrifugal system housing at the front of the tank,
d. channel or channels or large pipes for returning the water from the back compartment of the tank to the centrifugal system housing at the front of the tank, which also serves as support for the standard ergonomic underwater bench, and
e. electronic sensors used to control the flow of the current,
f. electronic displays, speed indicators, distance indicators, and other feedback indicators for the swimmer.
